(19) United States
(12) Patent Application Publication
(10) Pub. No.: US 2015/0295876 A1
(43) Pub. Date: Oct. 15, 2015

(54) Message Scanning System and Method

(71) Applicant: HEADLAND CORE SOLUTIONS LIMITED, Hong Kong (SAR) (CN)

(72) Inventor: Neil Lionel Newman, Hong Kong (SAR) (CN)

(73) Assignee: HEADLAND CORE SOLUTIONS LIMITED, Hong Kong (SAR) (CN)

(21) Appl. No.: 14/437,801

(22) PCT Filed: Oct. 24, 2013
(86) PCT No.: PCT/IB2013/002651

§ 371 Date: Apr. 22, 2015

Related U.S. Application Data
(60) Provisional application No. 61/788,582, filed on Mar. 15, 2013.
(60) Provisional application No. 61/718,222, filed on Oct. 25, 2012.

(51) Int. Cl. H04L 12/58; G06F 17/30

(52) U.S. Cl. CPC H04L 51/22; G06F 17/3053

(57) ABSTRACT

A system for sorting electronic messages having at least one computer to execute instructions stored on a computer-readable medium. The system scans a message in order to identify terms in the message listed in a first database and provides a message score to the received message based on the presence of any identified terms. At least one action is taken if the first message score is higher or lower than a certain value. If the first message score is higher than a second message score of a second message, then the first message is ranked more important than the second message. Messages may be placed within a score-ranged category. The message score may be determined by combining the weights of identified terms. Terms identified in the received message may be compared with terms in a second database. The received message is preferably put into at least one of at least two categories including a first category for incoming messages with matched and identified terms.

### RELATED APPLICATIONS

Priority is claimed from U.S. Provisional Patent Application No. 61/718,222 filed Oct. 25, 2012 entitled “Message Scanning System and Method” and U.S. Provisional Patent Application No. 61/788,582 filed Mar. 15, 2013 entitled “Message Scanning System and Method”, the teachings of which are both hereby incorporated by reference herein.

### BACKGROUND OF THE INVENTION

1. Field of the Invention

This invention relates to systems and methods for monitoring and sorting digital messages.

2. Description of Related Art

Digital messages, including electronic mail, or e-mail, are rapidly exchanged at very high volumes within a wide variety of professions or businesses. Presently, software applications are provided for sorting these messages by various values or data, typically relying on if-then logic based programming to sort incoming messages. For example, an e-mail sorting program may be utilized for determining if a first person is the sender of an e-mail, or if an e-mail contains a particular phrase in the first subject line, then that e-mail is forwarded to a first account, otherwise the e-mail is forwarded to a second account or deleted. These systems then display the messages chronologically, by sender, or another user selected value. In order to discern the importance of the subject matter, the user must then read each e-mail to determine the contents therein, a process which can take several hours if hundreds or thousands of messages are to be reviewed to determine their importance.

### SUMMARY OF THE INVENTION

A system and method for sorting electronic messages includes receiving an incoming electronic message; scanning the received message in order to identify terms in the electronic message listed in a first database; comparing terms identified in the message with a list of terms in at least one additional database and determining if the identified terms match with at least one term in the at least one additional database; and categorizing the electronic messages into at least two categories including a first category for incoming messages with matched and identified terms.

Additionally, the system attributes a weight to one or more aspects or features of an incoming message. The system calculates a total of a message's weighted aspects or features and provides the message with a score proportional to the importance of the message. A plurality of such scored messages are ranked by score in order of importance, rather than by order of receipt or by other existing message listing conventions. Examples of a message's features that can contribute to or detract from its overall score include the following: a) relative importance of the sender (boss, spouse, client, etc.); b. origination state of the message (e.g., is it an original message, a reply to my message, a reply to a reply, etc.); c. the recipient's status (direct recipient, CC, BCC, etc.); d. presence or absence of key terms in the subject field; e. presence or absence of key terms in the body of the message; and others.

In one aspect of the invention, the invention is a system for sorting electronic messages. The system includes at least one computer to execute instructions stored on a computer-readable medium. The instructions are configured to: a) receive a first incoming electronic message; b) scan the first received electronic message in order to identify terms in the first received electronic message listed in a first database; c) provide a first message score to the first received electronic message based on the presence of one or more identified terms in the first received electronic message; and d) take at least one action if the first message score is higher or lower than a certain value. Preferably if the first message score is higher than a second message score of a second received electronic message, then the at least one action taken is to rank the first received electronic message as more important than the second received electronic message. Optionally, if the first message score is higher than a predetermined threshold, then the at least one action taken is to halt delivery to a recipient of the first received electronic message pending managerial or supervisory review of the first received electronic message. Alternatively or in addition, if the first message score is within a first predetermined range of scores, then the at least one action taken is to place the first received electronic message into a first message category corresponding to the first predetermined range of scores.

In one embodiment of the invention, different terms in the first database are provided with different weights, and the first message score is determined by combining the weights of identified terms in the first received electronic message. The same identified term in the first received electronic message may be assigned different weight depending on the location of the identified term within the first received electronic message.

In one embodiment of the invention, the instructions are further configured to: e) compare terms identified in the received electronic message with a list of terms in at least one additional database and determining if the identified terms match with at least one term in the at least one additional database; and f) categorize the received electronic message into at least one category out of at least two categories including a first category for incoming messages with matched and identified terms.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a schematic diagram of a system in accordance with the disclosure as exemplified in a financial context; FIG. 2 is a common term table illustrating a spreadsheet with finance-related categories;

FIG. 3 is an embodiment of an output screen illustrating an application for displaying sorted messages;

FIG. 4 is a schematic diagram of the scanning engine used in the system of FIG. 1;

FIG. 5 is a schematic diagram illustrating an example flow chart for input and output information used in the system of FIG. 1 for finance-related information and messages;

FIG. 6 is the output screen of FIG. 3 as shown on an output device; and

FIG. 7 illustrates a system architecture for a computer system such as a server, work station or other processor on which the disclosure may be implemented.

FIG. 8 is a schematic diagram illustrating an embodiment of the invention managing multiple sources of messaging.

FIG. 9 is a schematic diagram of an embodiment of the invention halting an incoming message.

FIG. 10 is an embodiment of the invention flagging an incoming message.

FIGS. 11-23 depict a series of exemplary screenshots of applications of a message scanning and prioritizing system in accordance with the invention.

FIG. 24 is a schematic diagram of a thesaurus of a message scanning and prioritizing system in accordance with the invention.

FIG. 25 is an exemplary screenshot of potential actions to be taken by the system per instruction by Compliance upon reviewing a captured message.

### DETAILED DESCRIPTION OF THE DISCLOSURE

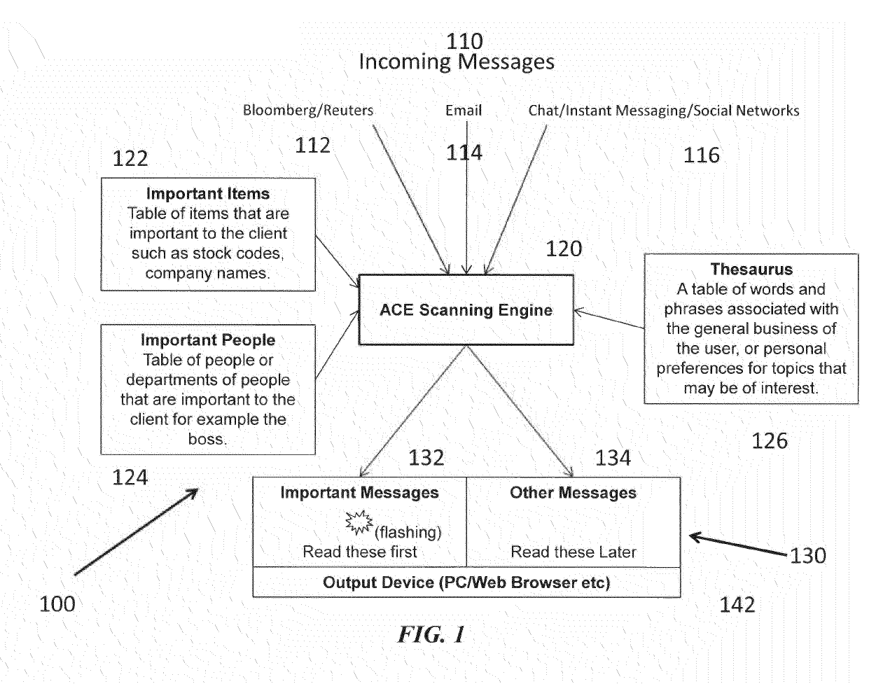

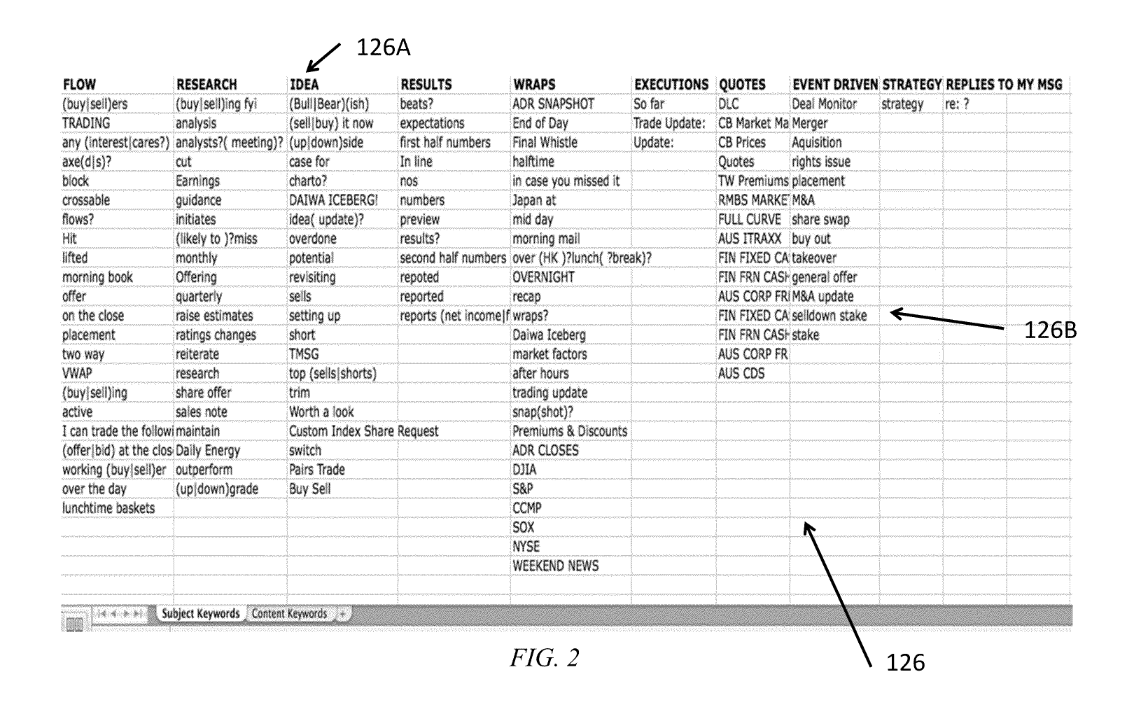

Description will now be given with reference to the attached FIGS. 1-25. It should be understood that these figures are exemplary in nature and in no way serve to limit the scope of the invention, which is defined by the claims appearing below and equivalents thereof.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

With reference now to FIG. 1, an embodiment of a system 100, in accordance with the disclosure, is provided for sorting and categorizing incoming messages 110 through a scanning engine 120 and into categorized output categories 130, to be displayed or communicated through a digital output screen 140 on an output device 142. Incoming messages 110 include any known or to be developed forms of information communicable to scanning engine 120 through a digital or electronic medium which may include, but is not limited to, news reporting services 112 (such as Bloomberg®), electronic mail 114, or other digital messages 116 such as those delivered through instant messaging, SMS text messaging, or other social networking mediums. Once incoming messages 110 are scanned or processed through scanning engine 120, as described herein, in one embodiment, the messages are then advantageously outputted into at least two categories 130, such as important messages 132 and other messages 134, and may further advantageously alert 136 a user of system 100 when an incoming message is sorted into a certain output category 130. Alert 136 may for example include an audio alert or a visual alert, such as the icon illustrated in FIG. 1. As described herein, messages sorted as important messages 132 may be advantageously sorted or ranked for importance by engine 120 and displayed accordingly on screen 140. Preferably, all messages are scanned and, as a result of the scan, assigned a score based on a number of criteria to be discussed below.

Scanning engine 120, which may be referred to as the Alpha Core Engine (ACE), utilizes a series of tables or databases 122, 124, 126 in order to process incoming messages 110, in accordance with the disclosure. Engine 120 relies on a plurality of tables, including at least a first table 122 and a second table 124, as well as a table of common terms 126. In the embodiment illustrated in FIG. 1, a table of important items 122 and a table of important people 124 are maintained to assist engine 120 in categorizing messages 110. Important items table 122 is utilized for listing items, terms, phrases, codes, data, or other information which might appear in message 110 and are to be identified as important or high priority to the user. Additionally, important people table 124 is utilized for identifying people, departments, electronic mail addresses, physical mail addresses, or other information relating to the location or origin or destination for message 110 which the user considers important or high priority. When utilized together, tables 122 and 124 advantageously identify important information potentially contained within, or in association with, message 110 for engine 120 to identify in categorizing or arranging input message 110 into output message 130. It should be appreciated that additional tables or value spreadsheets can be utilized separately or in conjunction with tables 122, 124 of the illustrated embodiment. It should be further appreciated that the term information, as used herein, is contemplated within this disclosure to include any data which might be contained within message 110, including data found in message bodies, subject lines, address lines, attachments, metadata, tracking data, and other data known or to be developed which might be associated with a message or messaging system.

It should be understood and appreciated that tables 122 and 124 may be advantageously amended by a user of system 100, and in some embodiments table 126 may also be amended by a user. In the embodiment shown, the important things list or table 122 would include a list of items the user considers important, which might change depending on his professional advancement, daily requirements, and daily schedules, each of which may require table 122 to be updated or amended periodically. The important people list of table 124 of the illustrated embodiment is a list of people the user of system 100 wants to prioritize to read messages from them or discuss them first, which might include a supervisor, important client, or close family member. Additionally, different lists may be made amendable/modifiable by different people or classes of people, and different people may be provided with different levels of access (e.g., some may add new terms to a list but not modify or delete existing terms, while others may have full administrative rights thereto).

A common term or thesaurus table 126 may also be utilized by engine 120 in evaluating incoming messages 110. A representative embodiment of thesaurus table 126 is illustrated as FIG. 2 in the context of financial terms and phrases, although a variety of subjects and content, both general and specialized to particular subject matter areas, are contemplated within the disclosure. In the illustrated embodiment, thesaurus table 126 is a spreadsheet of phrases, words, and people comprising terms or keywords 126A commonly contained in messages for the subject area to be analyzed, which in the illustrated embodiment is a financial setting or context. Keywords 126A are divided into categories 126B, illustrated here as column headers. Each thesaurus table 126 may be advantageously developed to reflect the environment or context in which engine 120 is to be used. A series of thesaurus tables 126 might also be utilized in some embodiments, particularly in embodiments of system 100 where engine 120 is relied upon to categorize and sort messages 110 relating to more than one subject matter area. Continuing with the financial example of the illustrated embodiment, thesaurus table 126 might contain financial terms relating to, for example, stock trade ideas, mergers and acquisitions, and research reports. An embodiment of thesaurus table 126 for a legal context might contain keywords 126A for categories 126B relating to client requests, deadlines, and billing complaints, while a table 126 for the medical profession might be utilized to sort patient pharmaceutical providers or to identify lab test results. The inventive thesaurus could be used as a translation dictionary, e.g., displaying the same phrase in multiple languages when a phrase is identified and/or an identified phrase is selected (e.g., moused over by the user).

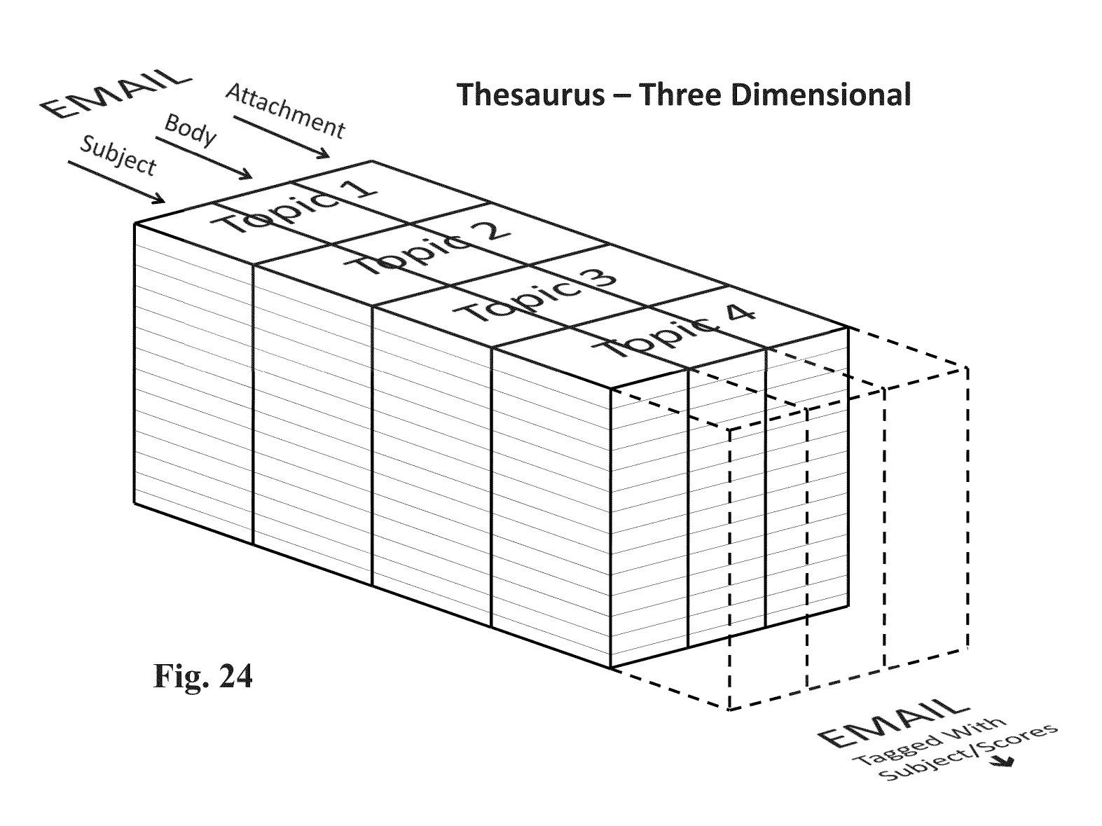

Conceptually, the thesaurus can be thought of as being three dimensional, its purpose is to determine the subject of an incoming that the sender is trying to convey, not merely to look for key words. Reference is made to FIG. 24. The incoming message “passes through” the thesaurus (in a manner to be described below) so that the system can i) determine what the sender is writing about and ii) associate one or more scores to the message relating to its importance to the reader. At that point, preferably, the message is tested against the list of important items.

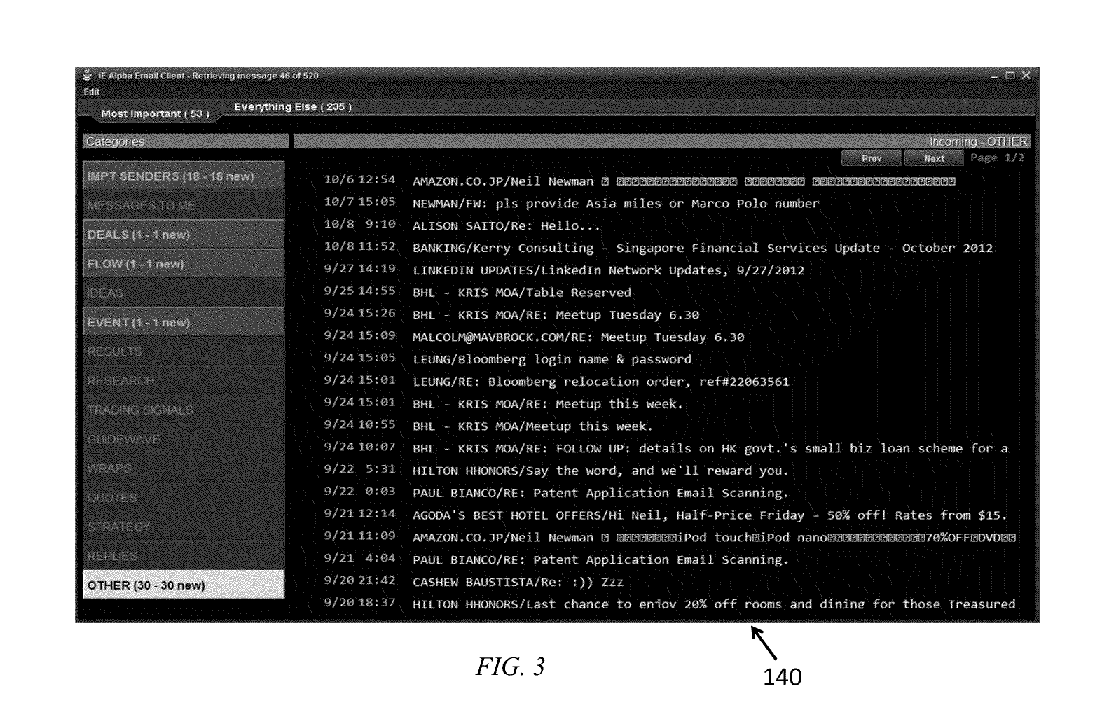

FIG. 3 illustrates one embodiment of the categorized output messages 130 displayed on an output screen 140. Although a variety of display presentations are contemplated within the disclosure, screen 140 illustrates output messages 130 categorized into important messages 132 and other messages 134 as separately accessible tabs to be easily and efficiently identified and selected by the user. Output messages 130 may be presented directly to the user by category or topic 136, with our without filtering by importance (although ranking by importance is preferred). For example, in the illustrated embodiment of screen 140, the messages 130 are displayed on the right-hand side, including sender, time, and subject matter information associated with the message, and the category to which each message is classified or categorized to is displayed on the left-hand side, with the highlighted category (as selected by the user) indicating which category is associated with the set of messages on the right hand side. Additionally, the tabs at the top of the top of the screen allow the user to switch between important categories of messages 132 and other categories of messages 134, so that the user may advantageously prioritize which messages 130 are viewed first.

In some embodiments the system 100 is interactively engageable through output screen 140 so that the user may adjust which data, values, words, or people are to be categorized as important or not important from output display 140. For example, a button or tool may be provided to quickly and conveniently reclassify messages incorrectly assigned as important or not important. The user may manually adjust what data values are to be reclassified as important values to be listed in tables 122, or 124. Furthermore, output messages 130 may have the terms or people which were identified as important highlighted on screen 140 so that the user may quickly determine what term or terms from tables 122, 124 was identified thereby resulting in the messages classification as important and priority ranking.

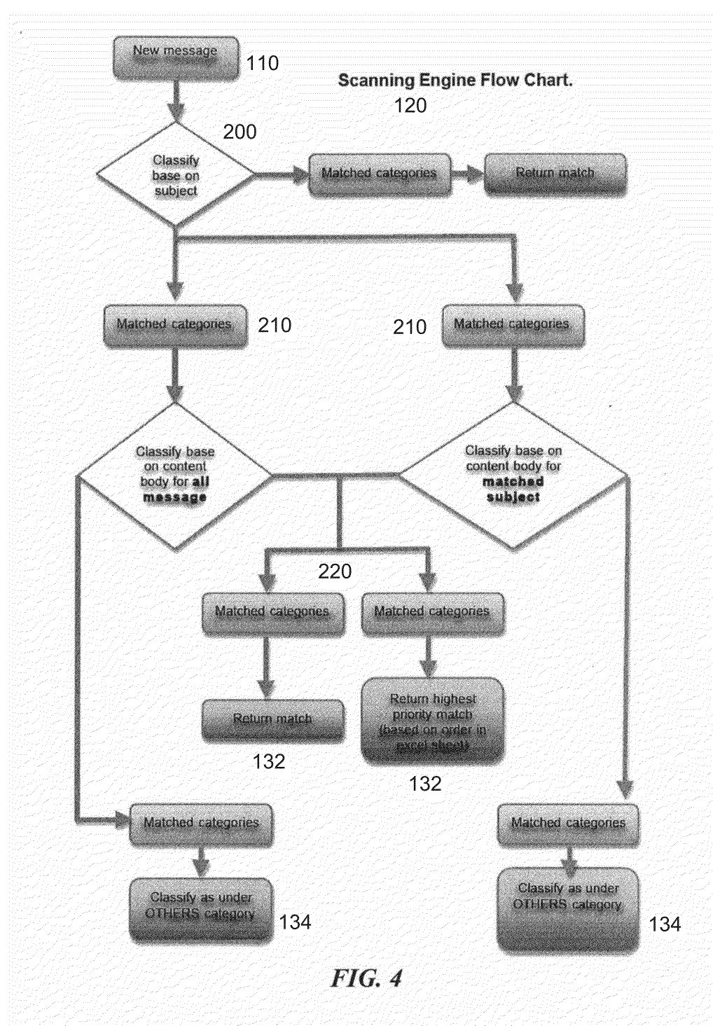

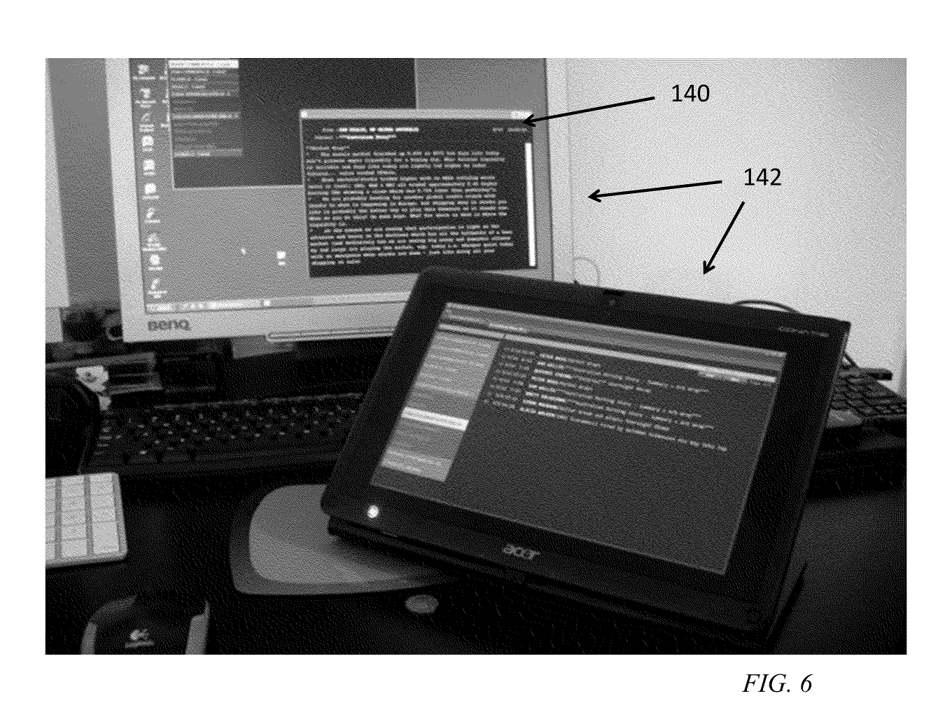

Referring now to FIG. 4, engine 120 is provided for scanning and categorizing input messages 110. In a first scanning step 200, scanning engine 120 uses known or to be developed artificial intelligence, such as a data mining application, to determine the subject and content of messages by using common term table 126 of phrases, words, and people used commonly in the area relevant to the user. From the scanned content, engine 120 classifies message 110 and matches them to one or more categories in a matching step 210. At this point, the message may be outputted for certain matched categories. For example, all messages having no phrases or people tabulated in the thesaurus 126 are matched to the “other” category (or even to a separate spam folder in some embodiments) while all messages sent from a spouse may be automatically classified as important, regardless of the content of the message or the existence of any important people or things found in lists 122, 124. In many cases, however, the important category matched messages 132 will proceed to a classification step 220 where message 100 may be given a priority ranking based on content of the message, based on the matched subject, or based on a combination of each. In classification step 220, engine 120 tests the sensitivity of the word or phrase against the important item list 122 and the important people list 124. If there is a hit or match between a word or phrase identified in thesaurus 126 and lists 122, 124, then message 110 is tagged and ranked compared to other high priority messages 132, while messages which fail to match a word or phrase with lists 122, 124 in step 210 are tagged or sorted as an other or unimportant message 134. Ranking of high priority messages 132 may depend on a variety of factors including frequency of matches, highest value of matches (for example in embodiments where important terms and people are listed in order of importance in tables 122, 124), or a combination thereof for ranking the important of messages 132. This ordering or ranking may be advantageously utilized by engine 120 to display important messages 132 in order of importance on output display 140. It is further contemplated that output messages 130 may be displayed in a variety of orders, in addition to in accordance with the ranking of importance, including, but not limited to, date, location and subject matter. Additionally, FIG. 6 illustrates how output display 140 may be viewed on an output device 142, which may include a personal computer or a laptop computer. The controls for user interface may be touch screen, standard mouse and keyboard, or other known or to be developed methods and devices.

System 100 and scanning engine 120 advantageously provides an improved method of scanning and sorting electronic input messages 110 over conventional e-mail sorting devices. In a prototype trial of scanning and sorting over 3,000 input messages 110, engine 120 achieved a 100% accuracy on identifying important items from list 122 and important people from list 124, and an 80% accuracy of determining an appropriate importance ranking of messages 132 based on subject or topic of the e-mail through the scoring system, with the higher score the more important topic. This advantageous ranking effect results in system 100 to serve as a significant labor saving device. Use of a prototype system 100 has been shown to reduce almost an hour of labor activity by a user for every 1,000 e-mails received and to be reviewed.

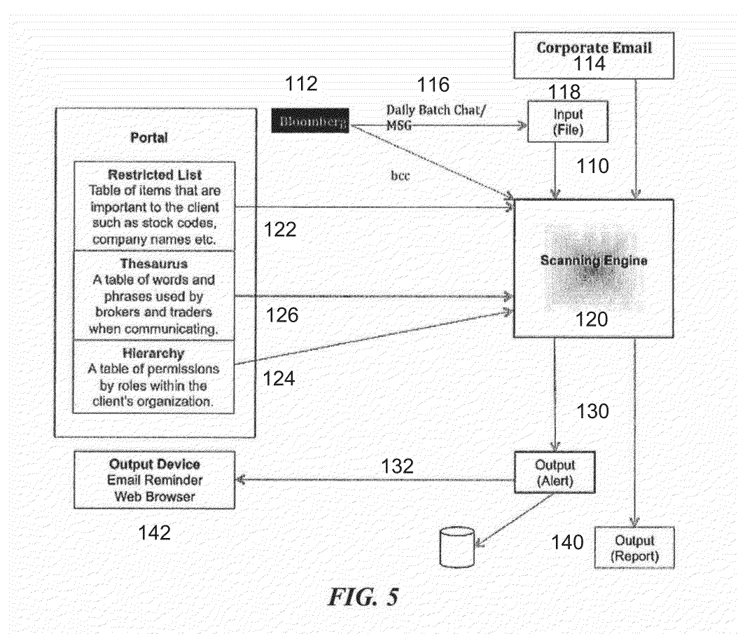

In reference now to FIG. 5, a representative embodiment of system 100 is illustrated as might be used by a user in the finance industry, and more particularly in an investment bank. Engine 120 receives input messages 110 from electronic mail 114, as well as subscription news service messages (such as Bloomberg®). In some embodiments, messages may be converted to a readable input file 118 prior to being scanned by engine 120. Input files 118 may also be useful for transforming analog or physical messages into a readable digital medium. Engine 120 then scans messages 110, and relies upon a restricted list 122 of items important to the user, a hierarchy list 124 of permissions by roles within the clients organization, and a thesaurus 126 of words and phrases used by brokers and traders when communicating. Input messages 110 are scanned and sorted through engine 120, in accordance with the disclosure, and may be outputted, for example, in a report showing categorized output messages 130, or through alerts sent to output device 142 for important messages 132.

One application for the scanning system is for compliance and monitoring. Considering the banking embodiment of FIG. 5, compliance and market surveillance staff would like to know if there is information leakage from a deal making corporate finance department to the stock traders and out to clients through salespeople, also known as insider information. In order to the monitor the communication exchanges, the bank staff may advantageously utilize system 100 to efficiently categorize potentially damaging input messages 110 as they are received. For example, the user's corporate e-mail 114 may be scanned and categorized in comparison to public finance reports and information as provided by a news reporting service 112. Restricted list 122 may include confidential information to be flagged or categorized, in accordance with the disclosure. The hierarchy table 124 may then be used to categorize the types of roles associated with each input message 110. Furthermore, the restricted list may order the confidential information between slightly confidential to highly confidential so users monitoring input messages 110 may quickly and efficiently identify which input messages 110 are most problematic and should be ordered first. If an important message 132 is identified, then an alert may be sent to an output device 140 to gain the attention of compliance personnel utilizing system 100.

Representative Computer System

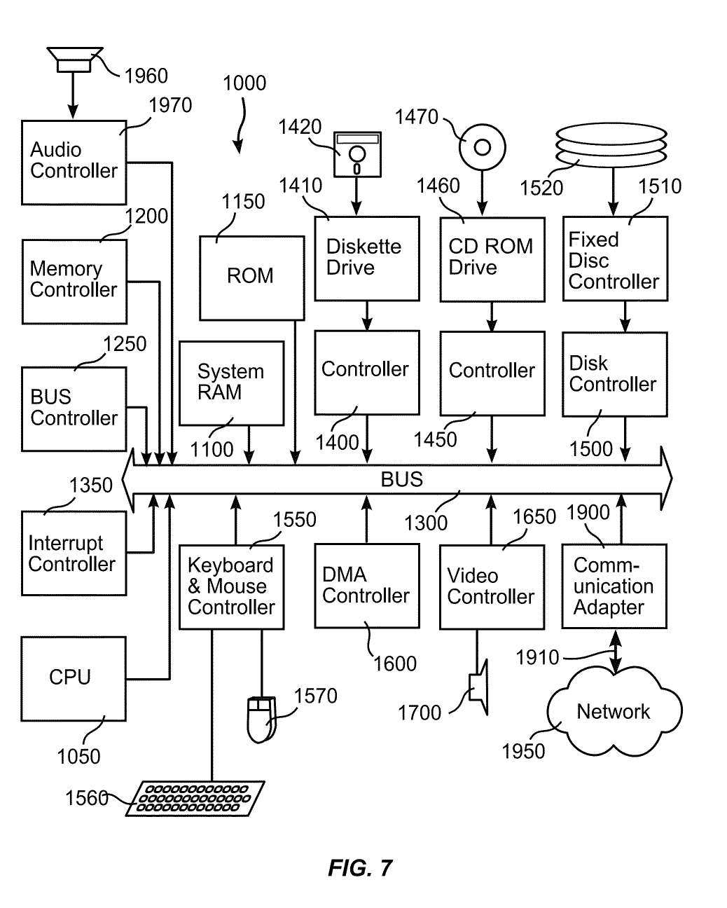

FIG. 7 illustrates the system architecture for a computer system 1000 such as a server, work station or other processor on which the disclosure may be implemented. The exemplary computer system of FIG. 3 is for descriptive purposes only. Although the description may refer to terms commonly used in describing particular computer systems, the description and concepts equally apply to other systems, including systems having architectures dissimilar to FIG. 7. It should be understood that system 1000 may be utilized in performing the processes and methods described herein, including the methods and functions described as the engine 120, functioning or performing as output device 142, in addition to any other process or method described in association with system 100, or a combination thereof.

Computer system 1000 includes at least one central processing unit (CPU) 1050, or server, which may be implemented with a conventional microprocessor, a random access memory (RAM) 110 for temporary storage of information, and a read only memory (ROM) 1150 for permanent storage of information. A memory controller 1200 is provided for controlling RAM 1100.

A bus 1300 interconnects the components of computer system 1000. A bus controller 1250 is provided for controlling bus 1300. An interrupt controller 1350 is used for receiving and processing various interrupt signals from the system components.

Mass storage may be provided by diskette 1420, CD or DVD ROM 1470, flash or rotating hard disk drive 1520. Data and software, including engine 120 of the disclosure, may be exchanged with computer system 1000 via removable media such as diskette 1420 and CD ROM 1470. Diskette 1420 is insertable into diskette drive 1410 which is, in turn, connected to bus 30 by a controller 1400. Similarly, CD ROM 1470 is insertable into CD ROM drive 1460 which is, in turn, connected to bus 1300 by controller 1450. Hard disk 1520 is part of a fixed disk drive 1510 which is connected to bus 1300 by controller 1500. It should be understood that other storage, peripheral, and computer processing means may be developed in the future, which may advantageously be used with the disclosure.

User input to computer system 1000 may be provided by a number of devices. For example, a keyboard 1560 and mouse 1570 are connected to bus 1300 by controller 1550. An audio transducer 1960, which may act as both a microphone and a speaker, is connected to bus 1300 by audio controller 1970, as illustrated. It will be obvious to those reasonably skilled in the art that other input devices, such as a pen and/or tablet, Personal Digital Assistant (PDA), mobile/cellular phone and other devices, may be connected to bus 1300 and an appropriate controller and software, as required. DMA controller 1600 is provided for performing direct memory access to RAM 1100. A visual display is generated by video controller 1650 which controls video display 1700. Computer system 1000 also includes a communications adapter 1900 which allows the system to be interconnected to a local area network (LAN) or a wide area network (WAN), schematically illustrated by bus 1910 and network 1950.

Operation of computer system 1000 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 1050 coordinates the operation of the other elements of computer system 1000. The present disclosure may be implemented with any number of commercially available operating systems.

One or more applications, such as an HTML page server, or a commercially available communication application, may execute under the control of the operating system, operable to convey information to a user.

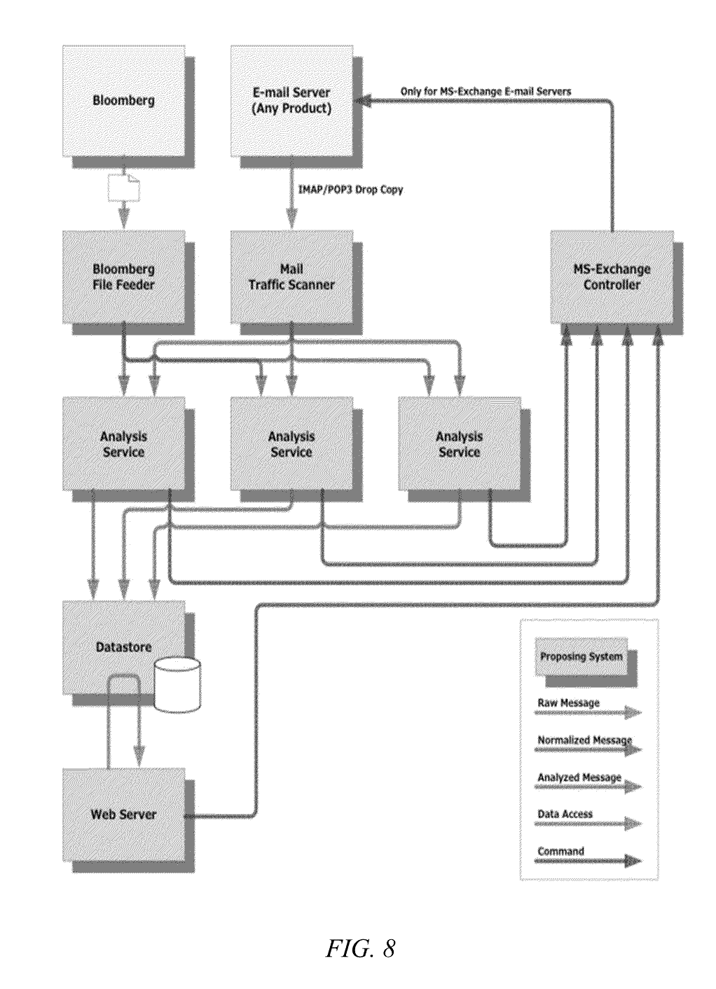

FIG. 8 is a schematic diagram illustrating an embodiment of the invention managing multiple sources of messaging. The system receives incoming raw messages from a number of different sources, such as e-mail, Bloomberg services, chat sessions, and the like (both known and to be developed in the future). Since messages from different sources may arrive in different formats, optionally, the system normalizes the messages into a standardized format prior to analysing same. The system then performs the inventive analysis on the message, comparing it to one or more tables of important terms, important people, the aforementioned thesaurus, and the like. As part of the analysis, the score of the message is determined, and an action occurs following the score, such as ranking the messages in order of importance, flagging a message for compliance review, blocking the transmission of the message, etc.

Some of the preferred specifics of how the system assesses the importance of a message, i.e., how weighting is applied and a score is determined, are discussed herein.

Initially, the thesaurus is preferably pre-populated with terms relevant to a specific industry. Users are then able to modify the terms according to their respective needs. Optionally, terms or entire categories of terms can be added as part of an upgrade process in an iterative process and as the lexicon of an industry evolves and new terms and concepts emerge.

The weighting of categories is determined in a similar manner. Initially, weighting is preferably predetermined based on accumulated knowledge of a specific industry. Individual inputs in the thesaurus can be weighted, as can an overall subject category. People are weighted in one or more levels of importance, e.g., very important, important, neutral, indifferent. Optionally, people may be provided with a numerical score within one of the above levels or instead of the above levels. Important items may also be weighted; optionally, important items may be provided with a binary allow/disallow variable.

Although the inventive system and method can be performed with similar types of lists, preferably, there are distinctions between a list of important items and important words or phrases appearing in the thesaurus. As described above in connection with FIG. 24, the thesaurus is multi-dimensional, in that it determines the subject of the e-mail by comparing words and phrases in the subject line and/or words and phrases in the body. The word or phrase list for subject and body may be different, but over time they will be modified gradually rather than drastically changed. By contrast, the list of important items is contemplated as changing far more frequently, such as a list of stock codes for a fund manager. In the translation dictionary feature, translations may be stored as phrase x language x categories to take advantage of the multi-dimensional aspect of the thesaurus.

There are benefits in having two separate lists/databases. For one, they work in unison and may be updated by different people. For example, the thesaurus may be generally static, and in this example the ‘Important Items’ contains a restricted list of stocks.

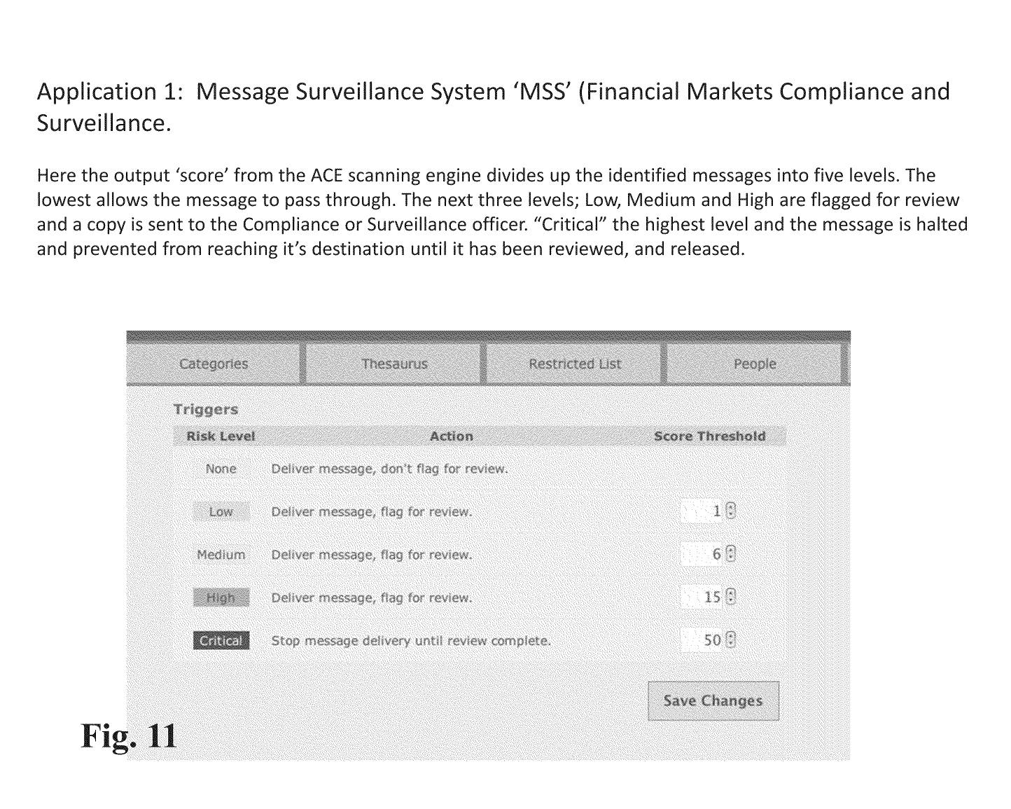

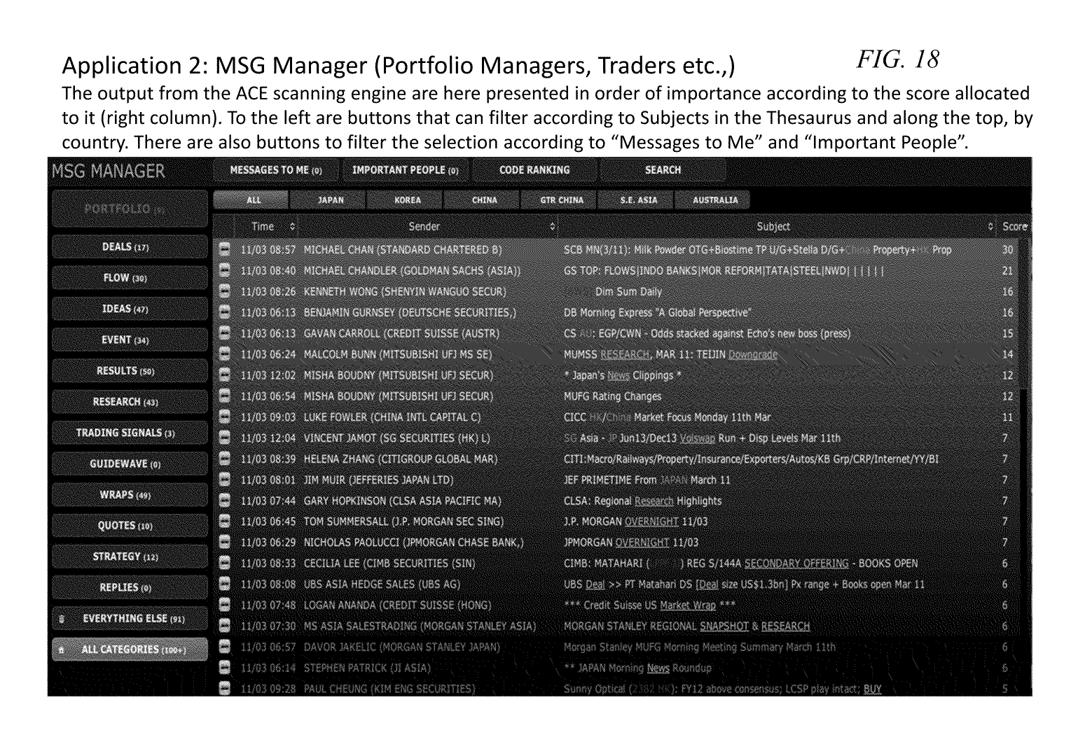

As an example, a Bank and an Investment Management Company are running the Message Surveillance System (MSS as seen in FIGS. 11-17, FIG. 25) and a Portfolio Manager, Brian, is running MSG Monitor (as seen in FIGS. 18-23). A statement such as “Heads Up Brian, I have an idea . . . ” in a message would unlikely be written in the body half way down, and if it were, it would be worth less (scored lower) than in the Subject line. From the Subject line the system can determine it is an “Idea” (high score, Brian likes those) and it specifically addressed to “Brian” (very high score) Brian would to want to see it.

Continuing with the same example; in the body it says “On 1398 HK I guarantee you will make money shorting this because I hear there is a placement”. 1398 HK is in Brian's important Items list (his portfolio, is running a short), ‘make money’ and ‘placement’ are important to Brian, but the sender who wrote it included inappropriate enticements and possibly some insider information that if Brian saw it would potentially wall-cross him and he could no longer trade in 1398 HK. If Brian did not have a position, it would be far less of an issue, but still inconvenient.

As long as the MSS is set up correctly, the Email won't leave the Bank as 1398 HK is in their ‘restricted list’ category of “Important Items”. The sender's employer is indeed involved in a deal and someone in Equity Capital Markets/Corporate Finance let it slip by.

However, if the message did get transmitted, Brian's Compliance Officers (who, for the purposes of this example, are more diligent) will not let the message be delivered to Brian, as their trap on the phrase “there is a placement” in the Thesaurus stops the Email and 1398 HK is in their portfolio as one of the “Important Items”.

Description of several methodologies of weighting a sender's importance are provided herein.

In one embodiment, when a sender mail arrives, the sender is labeled with a silver star (score 0) next to the name as a default. It can be selected (e.g., by clicking on the name), and it turns gold (scores 1), click on it twice and it turns purple (scores 2), click on a third time and it turns black (scores −1). If black/−1 is selected, the sender falls from view unless there is something important in the message to bring the overall score up. If the sender is made purple/+2, the sender is added to the important people list. Gold-starred senders appear above silver-starred senders. The actual numerical value can be varied, and multiple other symbols, levels, colors, grading systems, etc. can be employed within the same basic framework.

In another embodiment, a score according to department/function may be provided by the Human Resources department of a Bank, so the ‘importance’ of a person is going to be used differently, i.e. to observe traffic between, for example, Equity Capital Markets/Corporate Finance (a ‘Private’ section of the Bank) and Sales/Trading (a ‘Public’ facing department of the Bank).

In determining the overall score of a message, the scanning engine may preferably adopt one or more of the following steps.

Important People are assigned a numerical value according to the number associated with the Email address.

Subject/Body fields of Email: words, phrases and subjects each have scores of their own. These are preferably added up (and/or other various calculations performed), but preferably multiple instances of the same word are ignored. For example, if ‘idea’=1 and is in the subject field and then appears in the body 5 times, it would not score 6 for the message, it will score 2. “Strong Buy”=3 is in the subject also, but not in the body, score=5, and so on.

As another example, suppose nothing scores in the subject or the body of the e-mail, and the recipient has “blacklisted” the sender, yet the sender wrote something about 1398 HK which the recipient is short in his portfolio (and thus on the Important Items list). As a result, the mentioning of 1398 HK can add enough of a score to send the message to the top of the list or at least into the ‘Portfolio’ bucket.

The actual number of tables can be added to if there is another dimension to scan for, for example if the recipient has two portfolios or one ‘watchlist’ and one ‘portfolio’, the scoring may be different. Further, the scoring need not be solely numerical. For example, a stock in the portfolio may score ‘A’ but in the watchlist be scored ‘5’, and the output screen always puts messages that score ‘A’ into a Portfolio bucket.

Some lists may be updatable by the user/recipient remotely, e.g., a user can update his own Watchlist by sending e-mail to himself that includes a coded instruction to the ACE in the Subject Field of the email to “Update My Watchlist” then followed by a list of stock codes which becomes his new updated watchlist. Similarly, his ‘Portfolio’, which is maintained by his back office or a third party Portfolio Management System, can be updated remotely by sending a coded instruction by the same method to the ACE with the details of the new portfolio. This coded instruction may be private to the user. This coded instruction can take the form of one or more letters, numbers, symbols, and/or any other characters recognizable by the ACE.

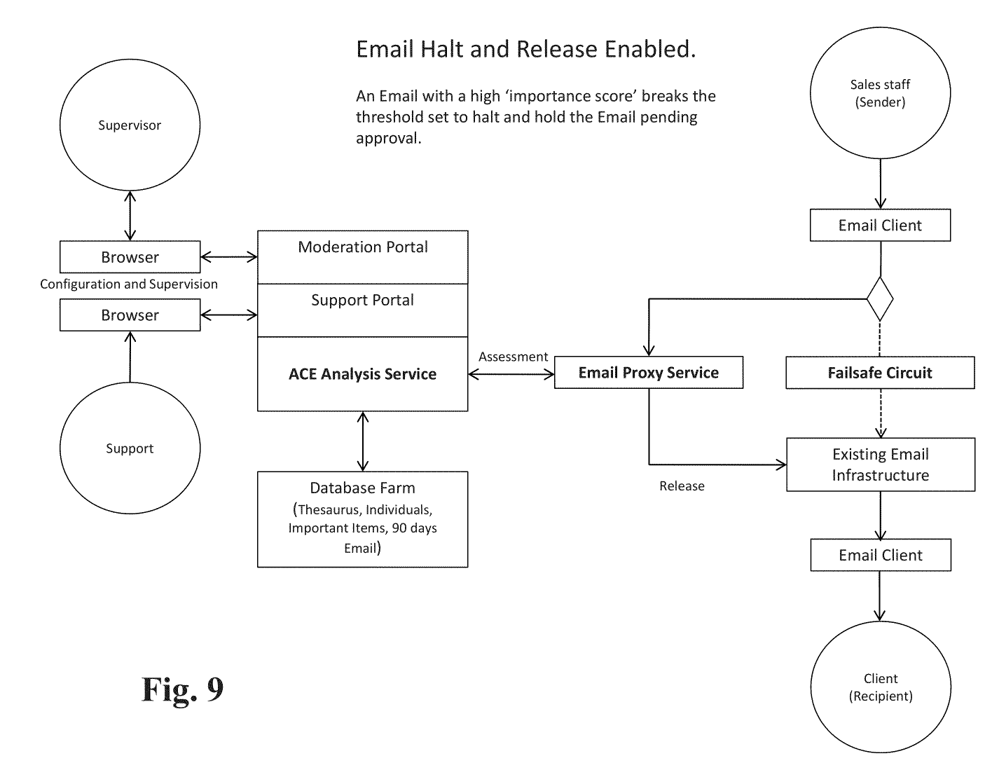

FIG. 9 is a schematic of an embodiment of the invention in which messages are pulled out of transmission and held pending review. For example, when an Email from sales staff/sender scores sufficiently high by the scanning engine, the proxy Email server captures the Email and routes it to the Surveillance Officer to review before it goes any further. The sender is preferably unaware it has been trapped (i.e., he preferably does not get a message back saying something has happened), and the intended recipient will not receive it unless and until it is released by Surveillance on the left side of the diagram. One example of such an occurrence may be staff accidentally sending a message marked ‘Internal Only” externally. At the top right, an e-mail comes in from the sender. The diamond therebelow is a setting by the client's IT, switching the Proxy Server/Analysis Service ‘On’. If it is ‘Off the Email goes through. The Failsafe Circuit is the existing Email architecture before the installation took place. The purpose of the Proxy Server is to interfere with the flow of Email, selectively capturing some while letting others go through. The Moderation Portal is the part the Compliance and Surveillance Officers use to review tagged Email. The Support Portal would be for modifying the settings within the ACE and the Proxy Server. The database farm contains all of the static data the ACE needs to perform its analysis: the Thesaurus, the list of Important Items, the list of Important People; and a store of recently received and sent messages. In the latter case, 90 days' worth of email is selected to keep the database size under control. Large institutions typically send/receive hundreds of thousands of messages daily and would keep their archives elsewhere.

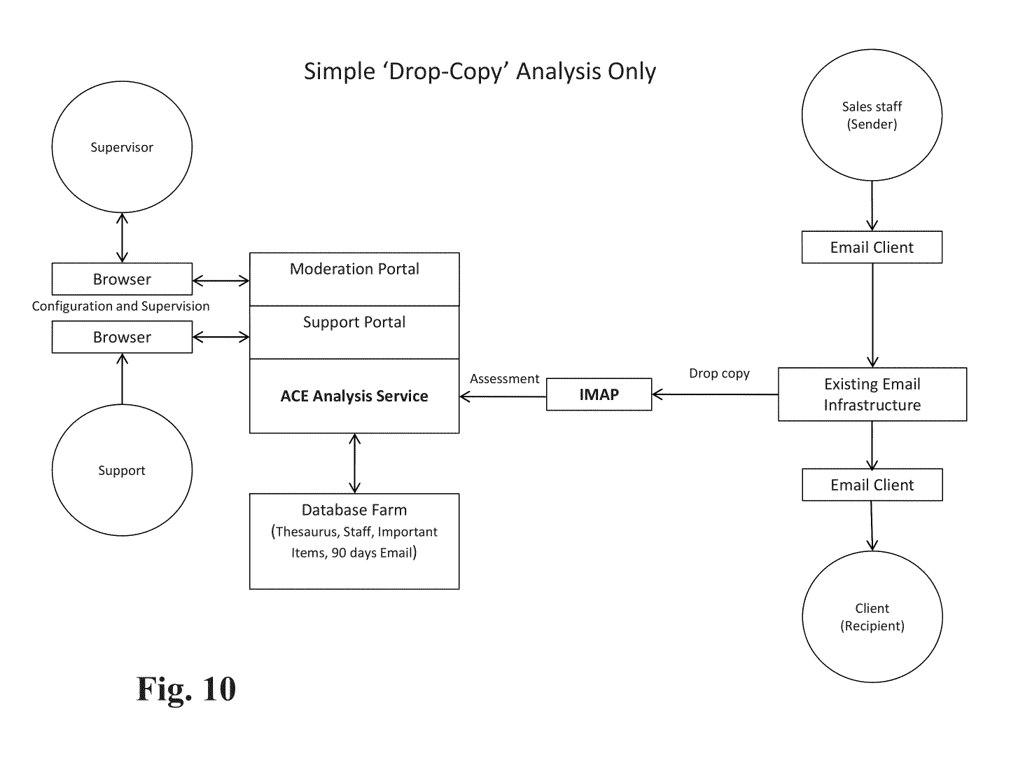

FIG. 10 is a schematic of an embodiment of the invention in which messages are flagged but not necessarily held. Here, the proxy server is disabled and so there is no halting of Email. Instead, optionally, a copy is analyzed and sent to the Surveillance Officer for review. This may be preferable for firms that do not want additional software in the existing email architecture or do not wish to halt the flow of messages. Internet Message Access Protocol is a known method of getting Email from a server; others may be employed instead or in addition thereto.

Description will now be provided for the post-analysis output of the system.

FIG. 11 depicts exemplary scoring thresholds or scores that may trigger a post-analysis event. The output ‘score’ from the ACE scanning engine divides up the identified messages into five levels (or more or fewer levels). The lowest allows the message to pass through. The next three levels; Low, Medium, and High are flagged for review and a copy is sent to the Compliance or Surveillance officer. “Critical” the highest level and the message is halted and prevented from reaching its destination until it has been reviewed, and released. The post-analysis event may simply be labeling a High, Medium, or Low risk Email depending on the scores it has picked up from the Thesaurus, or a “Critical” score in which the Email is halted by the Proxy Server. Other events may include routing “High” risk messages to a senior Compliance Officer, lower risk messages to more junior staff and messages with attached images (.jpg.tiff etc.), being diverted to a Compliance Officer designated to review such attachments.

The score thresholds are depicted in FIG. 11 as being adjustable. Each level may be assigned factory pre-set levels that may be altered after deployment. Typically, such alterations will be restricted to certain individuals in Compliance or Surveillance and their actions recorded in a database for audit/reports.

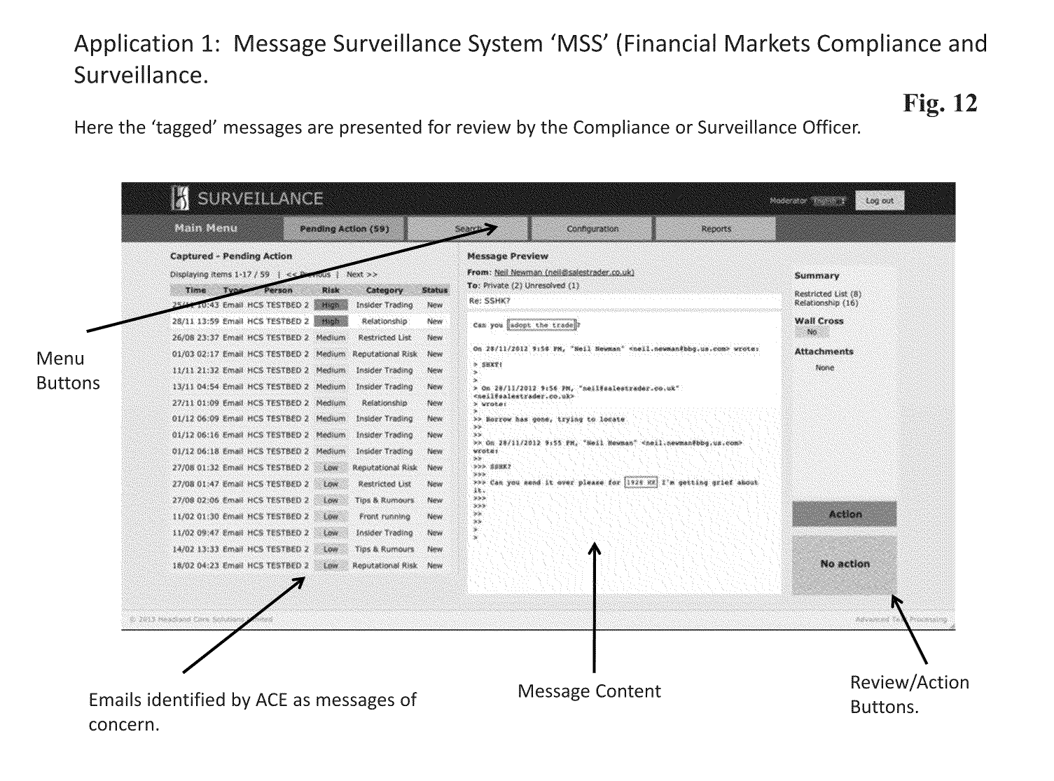

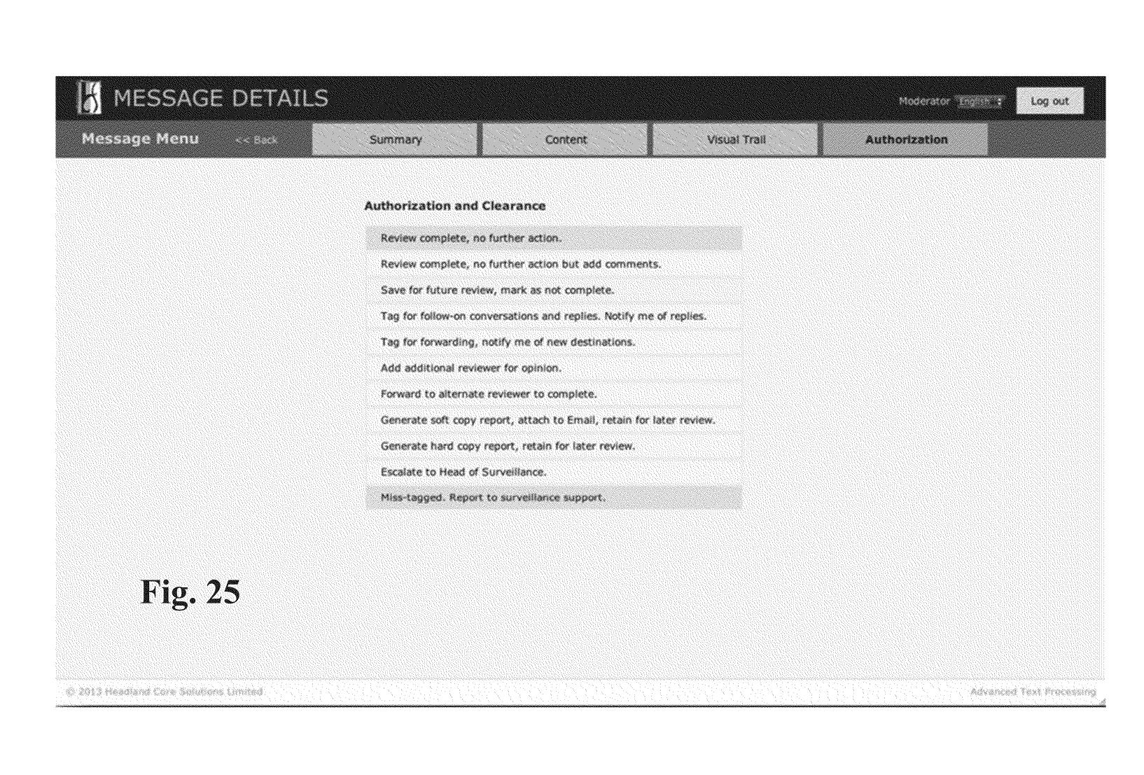

FIG. 12 depicts what a Compliance or Surveillance Officer would see post-processing of messages by the ACE scanning engine. All tagged messages are presented for review by the Officer. The left column includes a list of captured messages indicating time, type of message (e-mail, chat, etc.), assigned risk level (see FIG. 11), the relevant category, and their status. Immediately to the right thereof is a preview window so the Officer can see message content. The bottom right corner of FIG. 12 depicts Review/Action buttons. The “No action” button means the message will get passed through and no action will take place. The “Action” button takes the user to another screen (see FIG. 25) in which the Officer can instruct the system to take one or more actions based on the Officer's review of the message and its importance.

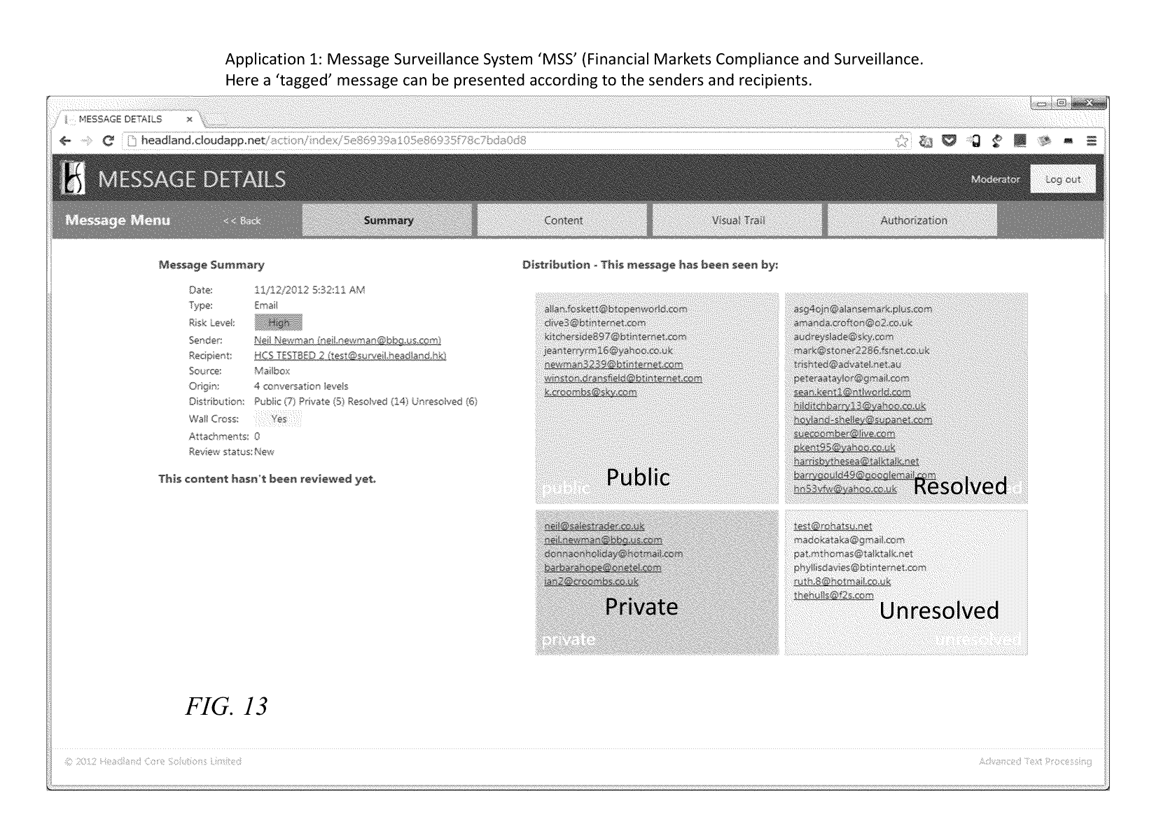

Upon selecting a specific captured message listed in FIG. 12, the Officer will typically need to drill down to see where a message has been. FIG. 13 depicts an exemplary screen shot of a selected message being presented according to the senders and recipients of the message. Senders and recipients may preferably be organized into one or more designations. In the exemplary version shown in FIG. 13, the designations are public, private, resolved, and unresolved. Private may refer to areas in an institution that are working on projects that are not ready to be discussed outside a closed group of people, for example deals being put together in Corporate Finance. These could include Research in many cases where reports are kept under wraps until cleared by the Supervisory Analyst and published. Public refers to the portions of an institution that interact with the outside world, e.g., Sales and Trading, institutional investors, Portfolio Managers, Buy-side Trading Desks, etc. This category may even include members of the general public. Resolved may preferably be lists of addresses known to the institution, for example, customers in the Customer Relationship Management (CRM) Software. Similarly, Unresolved may preferably be lists of addresses not necessarily known to the institution that represent potentially the highest risk for information leakages. Such unresolved addresses may include home e-mail addresses, the press, corporates, and the like.

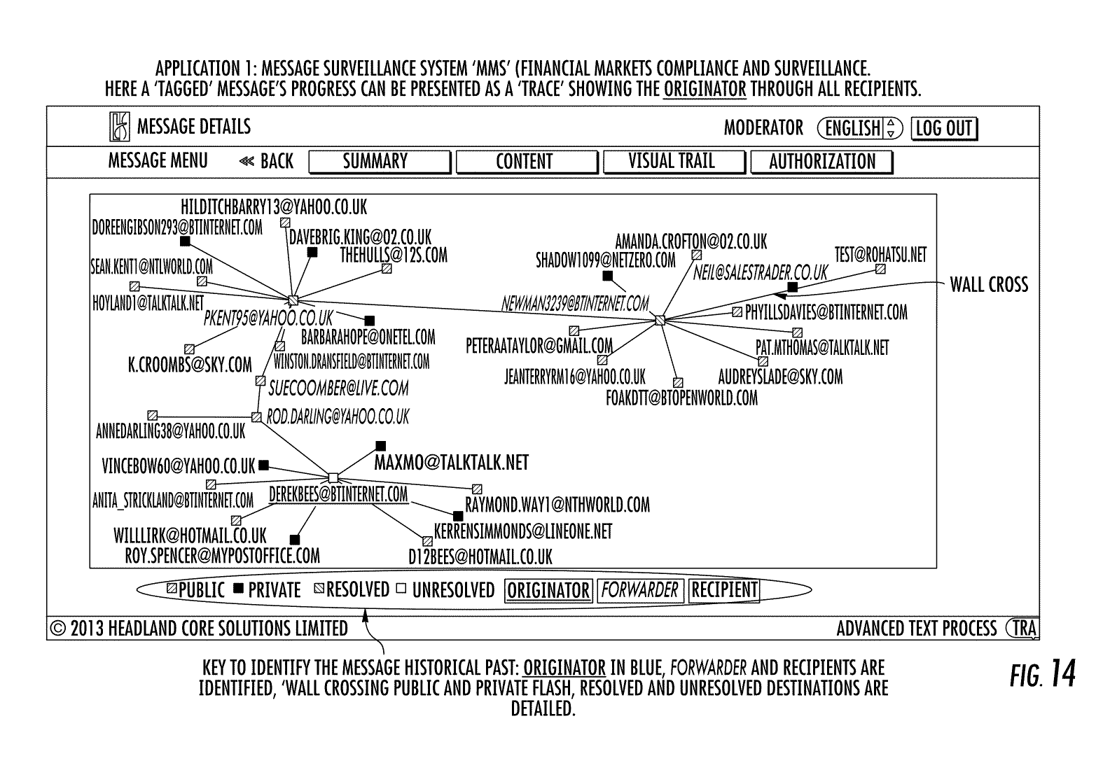

FIG. 14 represents a graphical presentation of the same or similar data as shown in FIG. 13, i.e., a selected message being presented according to the senders and recipients of the message. What is shown is the information contained in the header of an e-mail identified by the scanning engine to be of concern. Public, private, resolved, and unresolved statuses may be indicated by differently colored symbols, or by different shapes, or different sizes, and the like. The graphical presentation also delineates if a person/address is an originator, a forwarder, or a recipient. Every address of every forward is there, who sent it, and where it went. The graphical presentation gives the user an immediate view of possible damage control. Where a message has crossed from Public to Private for example (a potential wall-cross), the links are preferably highlighted, flashing, or are otherwise made more noticeable than non-wall-crossing links.

One advantageous feature of the graphical presentation of FIG. 14 is that the model is not static but rather dynamic, i.e., it can move. The Officer can click on any one of the addresses and pull/push the address apart from the rest of the cluster to obtain a better view of what a specific address did with the message in question.

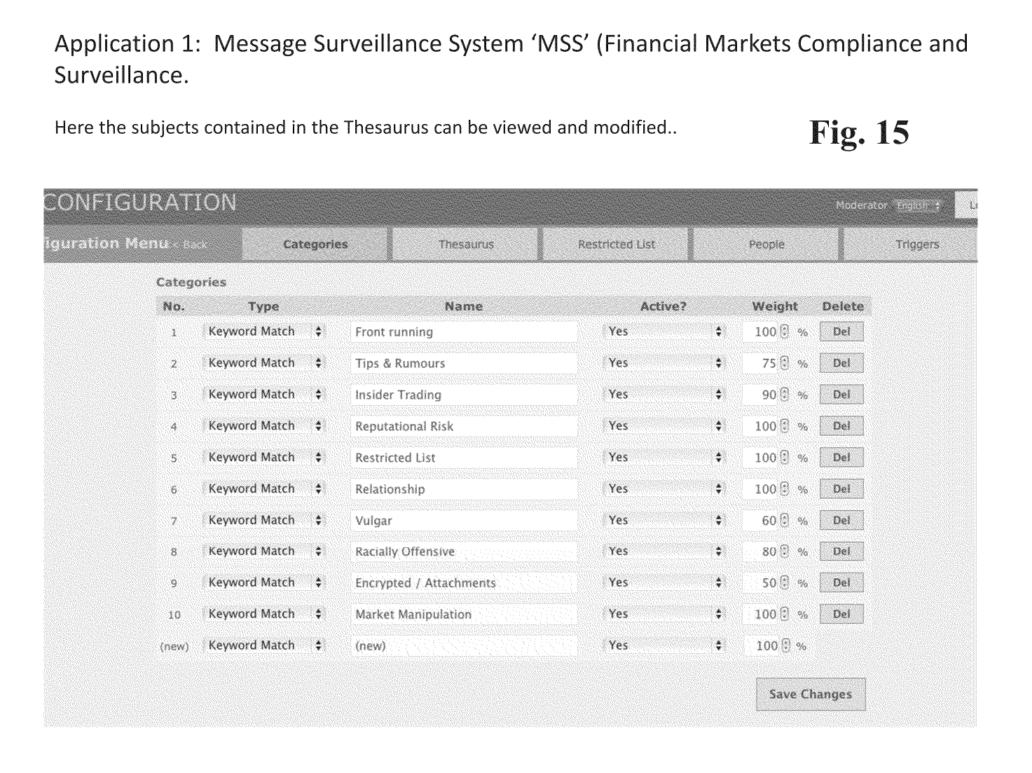

FIG. 15 depicts an exemplary screen shot of the “configuration” screen, i.e., what the user sees when clicking on the Configuration menu button at the top of FIG. 12. Here the categories/subjects contained in the thesaurus can be viewed and, if the user has permission, modified. As shown in FIG. 15, the type of match selected for all items is a keyword match. As another alternative, a pattern match may be employed. For example #### #### #### #### may be a credit card number or some kind of account number, while &######(#) may be a form of ID number. Other matching schemes are contemplated as well. Each term in a category is weighted as indicated in the “Weight” column, second from right.

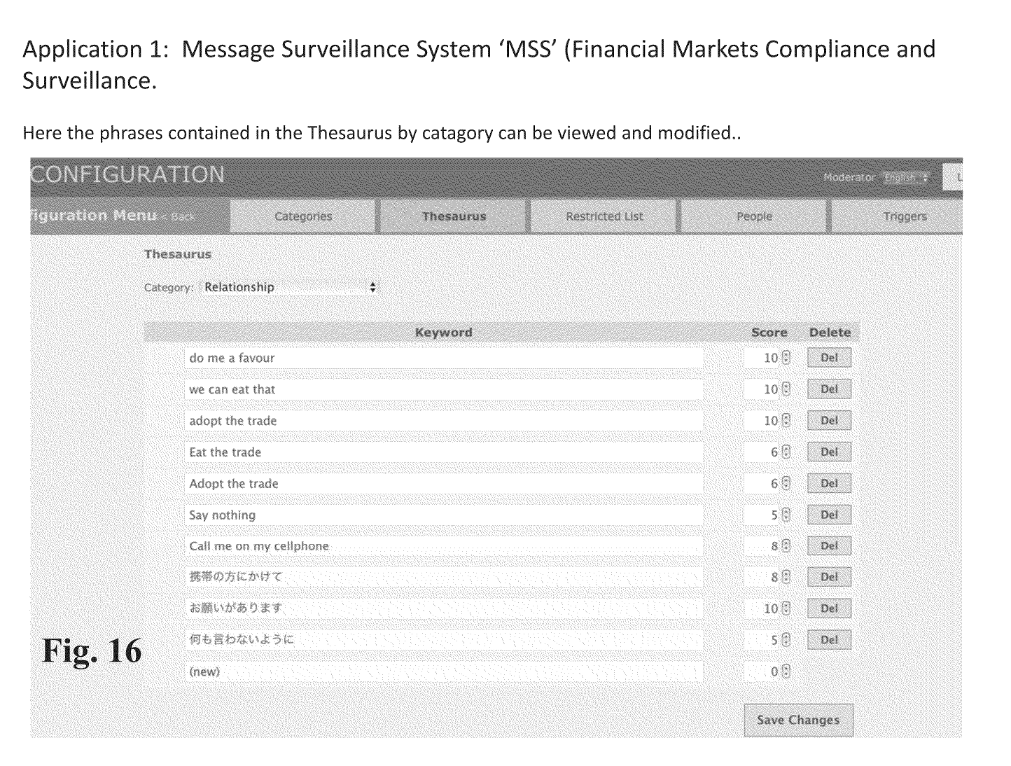

By selecting a specific category listed on FIG. 15, e.g., by clicking on the category number in the left column (or by similar means), the user is brought to a list of terms and phrases in the thesaurus that fall under the selected category as shown in FIG. 16. (Alternatively, the user may be brought to the FIG. 16 screen by another click-through methodology.) Here, a number of key words, phrases, or terms are listed, and each is provided a score that is modifiable by the appropriate parties.

Taking FIGS. 15 and 16 together provide an understanding of one form of message scoring contemplated by the invention. One scoring scheme includes simply adding up terms and then multiplying the term by a percentage weight for the category. Other rules may be employed, including but not limited to the following: limiting the number of times one would score multiple instances of the same term; scoring a term higher in the subject of the message than in the body; weighting of words based on location within the body, as people tend to write the most important thing within the first few words or lines (e.g., increased weighting applied within, e.g., the first 75 words, five lines, or the like); scoring a term lower if it appears in an attachment; etc.

As an example, take the message “Say nothing, call me on my cellphone.” Both of those terms fall under the “Relationship” category as shown in FIG. 16, which, for the sake of the example, is given a 95% weight. “Say nothing” has a score of 5, and “Call me on my cellphone” has a score of 8. Then the calculation for the message would be 5 (say nothing)+8 (call me on my cellphone)×95% (Relationship category weight)=12.35.

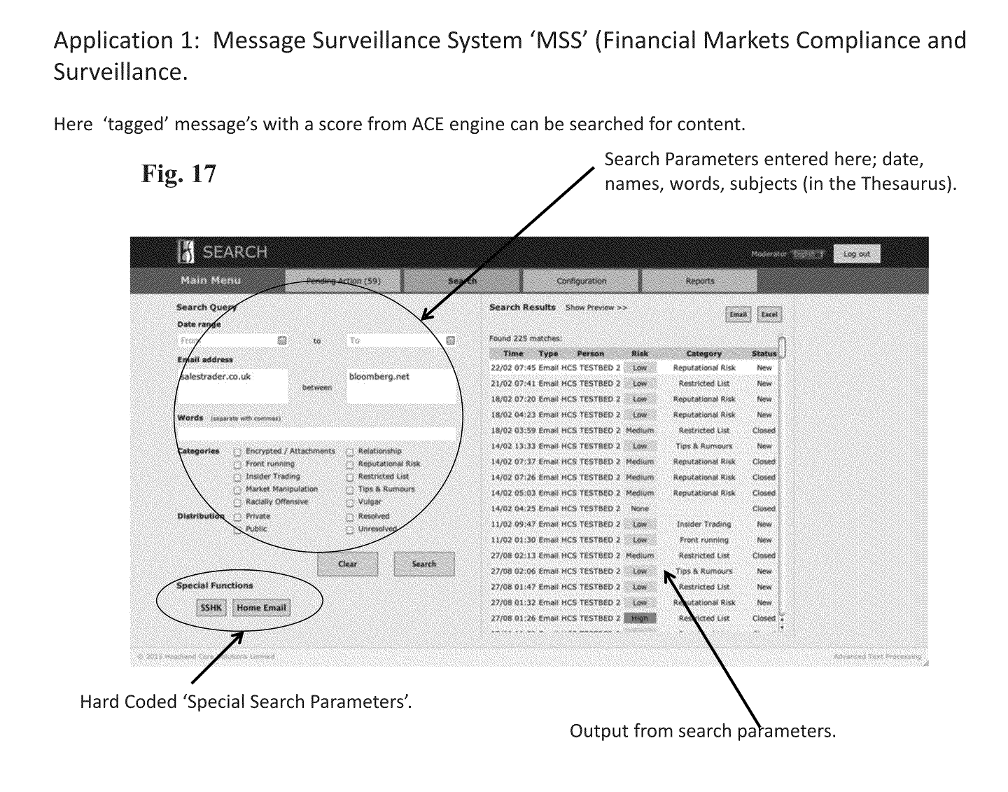

FIG. 17 depicts an exemplary screen shot of the “search” screen, i.e., what the user sees when clicking on the Search menu button at the top of FIG. 12. Here, captured messages with a score from the scanning engine can be searched for content. Search parameters are enterable in the fields in the left side of the screen, e.g., date, names, words, categories, etc.

Some search functionality may be hard coded that the user cannot modify. For example, some Surveillance Officers have concerns about things that employees send to home email addresses. A way to review these is to have a button that sets one or more search parameters for all typical home e-mail destinations (e.g., Yahoo!, Gmail, Hotmail, etc.). Another non-limiting example of a hard coded search function is short sale notification. The exemplary SSHK button shown in FIG. 17 represents a short sale notification in Hong Kong that a fund manager has to send an execution broker before the broker can execute a short sale. In this context, a “SSHK” function would find all relevant messages, and the user can either attach them all to an Email and send them to the person doing the reconciliation, or extract the information from the Email and drop it in Excel. (Conventionally, messages are generally printed out by the broker and then reconciled with the trade records manually, which is time intensive and laborious.)

FIGS. 18-23 show various outputs and screen shots for a message managing application incorporating and/or otherwise utilizing the inventive message scanning system and method. This application is useful for portfolio managers, traders, and the like, i.e., the intended sender/recipient of such messages, rather than their Compliance/Surveillance overseers.

In FIG. 18, the output from the scanning engine is presented in order of importance according to the score allocated to it (right column). To the left are buttons that can filter according to Categories in the Thesaurus and along the top, by country. There are also buttons to filter the selection according to “Messages to Me” and “Important People”.

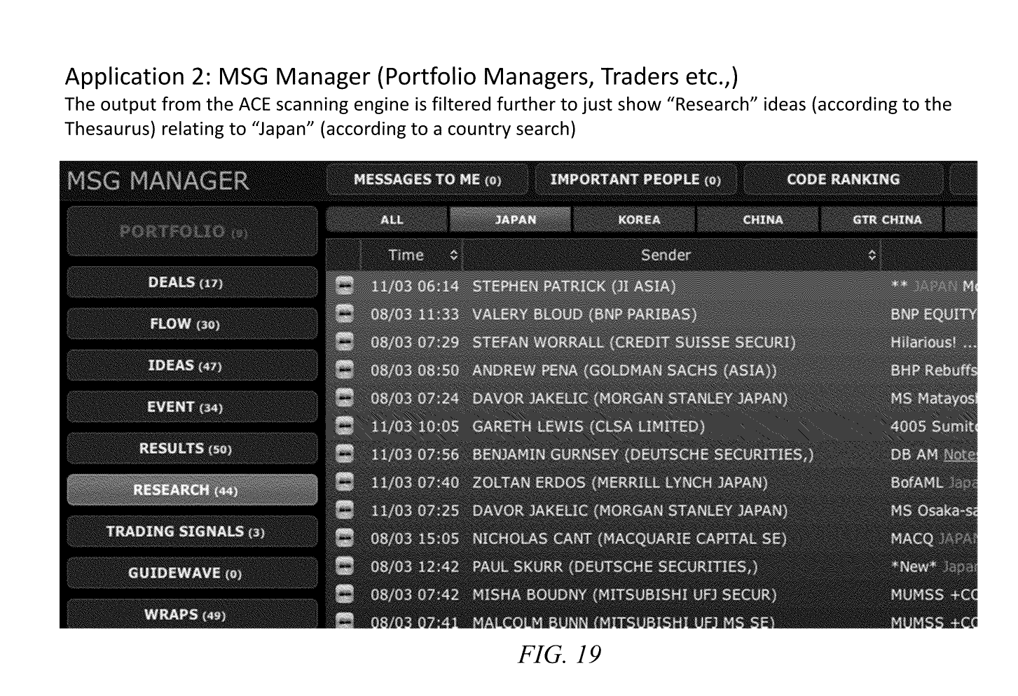

In FIG. 19, the “Research” and “Japan” buttons of FIG. 18 have been selected. Here, the output from the scanning engine is filtered further to just show “Research” ideas (according to the Thesaurus) relating to “Japan” (according to a country search).

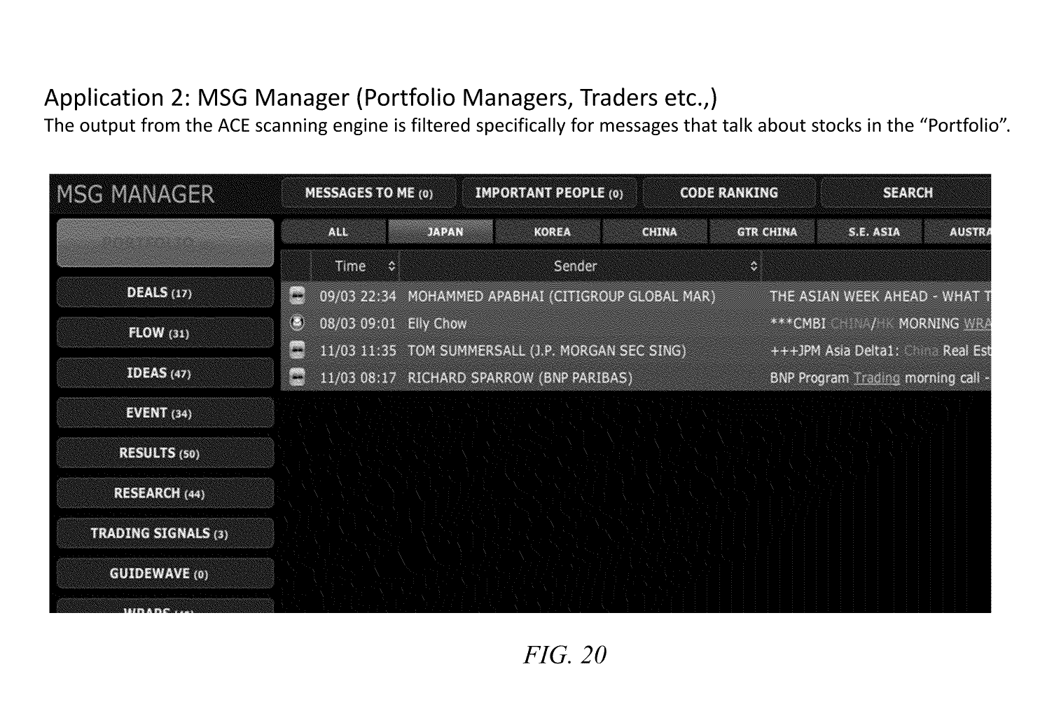

In FIG. 20, the “Portfolio” button of FIG. 18 has been selected. Here, the output from the scanning engine is filtered specifically for messages that talk about stocks in the “Portfolio”.

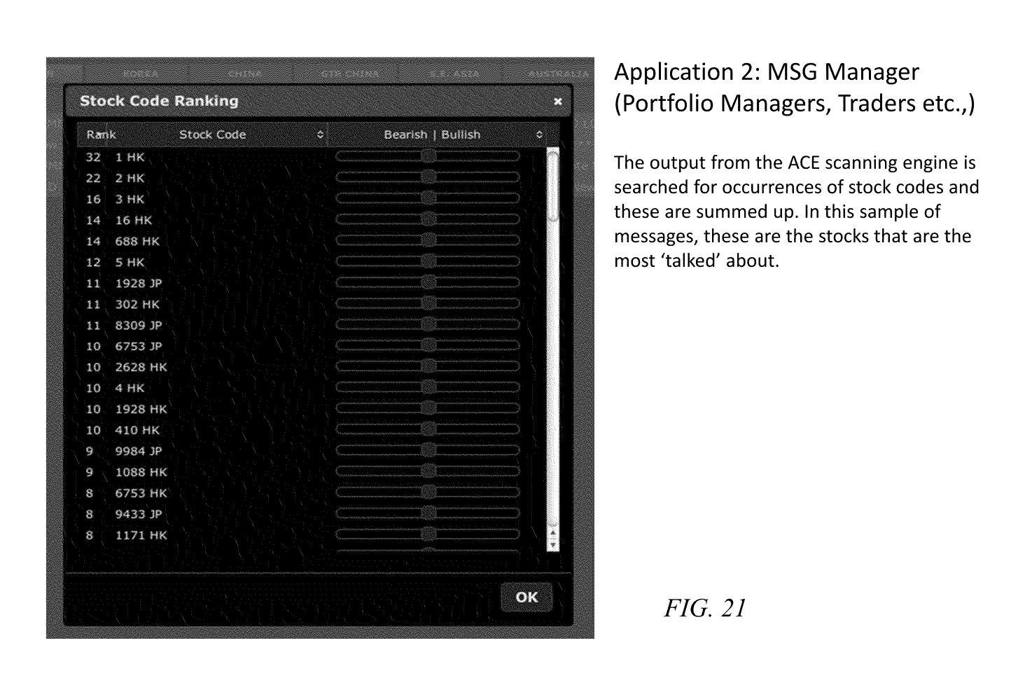

In FIG. 21, the “Search” button of FIG. 18 has been selected. Here, the output from the scanning engine is searched for occurrences of stock codes and these are summed up. In this sample of messages, these are the stocks that are the most ‘talked’ about. On the right side of the ranking is a toggle meter labeled “Bearish|Bullish.” In one embodiment, the toggles are manually set by the user, and the total appears as a Bull/Bear indicator on the bottom left corner of FIG. 18. Optionally, the scanning engine can be programmed to determine the Bullishness or Bearishness of each incoming message. The scanning engine, in such a case, would prioritize looking for words that are generally bullish or generally bearish and add a ‘sentiment’ score to the message. E.g., “strong buy” might be given a “Bullish” weighting, whereas “strong sell” would be weighted as “Bearish.”

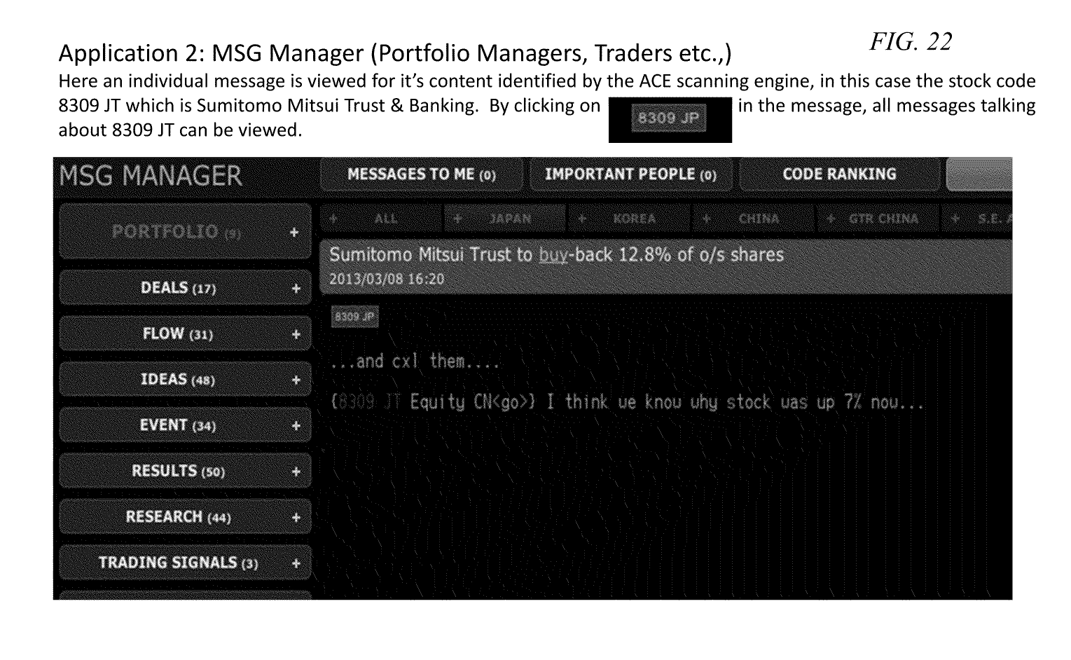

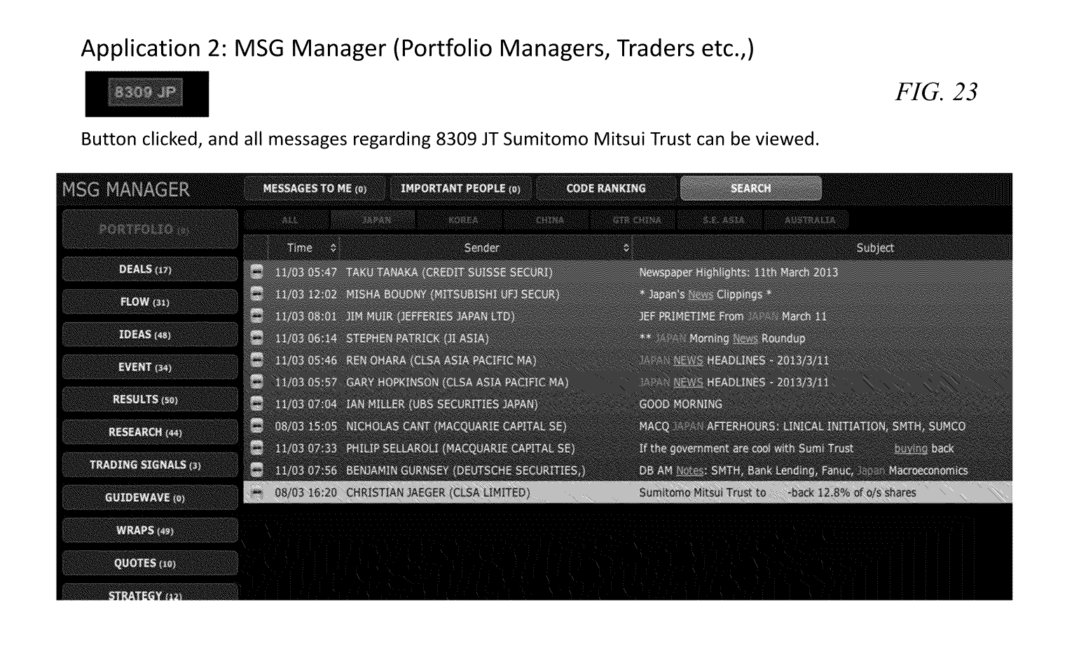

In FIG. 22, an individual message is being viewed for its content identified by the scanning engine. In this case, the content in question is the stock code 8309 JP which is Sumitomo Mitsui Trust & Banking By clicking on 8309 JP in the message, all messages talking about 8309 JP can be viewed. That search result is displayed in FIG. 23, in which the 8309 JP button has been clicked, and messages regarding 8309 JP are listed and viewable.

Other Filtering Mechanisms are Contemplated.

It will be appreciated by persons skilled in the art that the present disclosure is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the disclosure.

All references cited herein are expressly incorporated by reference in their entirety. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A system for sorting electronic messages, the system comprising:
at least one computer to execute instructions stored on a computer-readable medium, the instructions configured to:
a) receive a first incoming electronic message;
b) scan the first received electronic message in order to identify terms in the first received electronic message listed in a first database;
c) provide a first message score to the first received electronic message based on the presence of one or more identified terms in the first received electronic message; and
d) take at least one action if the first message score is higher or lower than a certain value.

2. A system for sorting electronic messages according to claim 1, wherein, if the first message score is higher than a second message score of a second received electronic message, then the at least one action taken is to rank the first received electronic message as more important than the second received electronic message.

3. A system for sorting electronic messages according to claim 1, wherein, if the first message score is higher than a predetermined threshold, then the at least one action taken is to halt delivery to a recipient of the first received electronic message pending managerial or supervisory review of the first received electronic message.

4. A system for sorting electronic messages according to claim 1, wherein, if the first message score is within a first predetermined range of scores, then the at least one action taken is to place the first received electronic message into a first message category corresponding to the first predetermined range of scores.

5. A system for sorting electronic messages according to claim 1, wherein different terms in said first database are provided with different weights, and the first message score is determined by combining the weights of identified terms in the first received electronic message.

6. A system for sorting electronic messages according to claim 1, wherein the same identified term in the first received electronic message is assigned different weight depending on the location of the identified term within the first received electronic message.

7. A system for sorting electronic messages according to claim 1, said instructions further configured to:
e) compare terms identified in the received electronic message with a list of terms in at least one additional database and determining if the identified terms match with at least one term in the at least one additional database; and
f) categorize the received electronic message into at least one category out of at least two categories including a first category for incoming messages with matched and identified terms.
